(19) United States
(12) Patent Application Publication
(10) Pub. No.: US 2012/0301801 A1
(43) Pub. Date: Nov. 29, 2012

(54) SYSTEMS AND METHODS FOR CONVERTING RECEIVED STORED ENERGY

(76) Inventor: Alex Wein, Harleysville, PA (US)

(21) Appl. No.: 13/419,979

(22) Filed: Mar. 14, 2012

Related U.S. Application Data
(60) Provisional application No. 61/490,328, filed on May 26, 2011.

(51) Int. Cl. H01M 8/18; C25B 9/08; C25B 1/46; C25B 9/00

(52) U.S. Cl. 429/417; 204/242; 204/252; 205/343

(57) ABSTRACT

A system and method for converting, receiving, and/or storing energy to, amongst other things, (i) generate hydrogen and chlorine gas, and sodium hydroxide using, for example, a chlor-alakali processing apparatus; (ii) generate hydrochloric Acid (HCl) using, for example, a novel HCl fuel cell; (iii) utilize HCl as a catalyst to hydrolyze cellulosic material into basic sugar water and HCl solution; (iv) utilize an acid/base neutralization combined with electrolysis as a precursor to separating HCl from a sugar water and HCl solution; (v) convert HCl to hydrogen and chlorine gas; (vi) provide a method by which HCl and heated water can be used in the transformation of cellulosic materials into sugars for fermentation into ethanol and/or butanol (vii) provide a method by which acidic waste and additional biomass can be processed through a bio-reactor into methane, fatty acids, and fertilizer; and/or (viii) provide for the desalinization of salt water/brine.

### CROSS REFERENCE TO RELATED APPLICATIONS

The application claims benefit to provisional application No. 61/490,328 filed on May 26, 2011, which is incorporated by reference herein in its entirety.

### FIELD OF THE INVENTION

The present disclosure generally relates to systems and methods for storing energy (e.g., supplied from intermittent power sources, off-peak power sources, etc.) using the conversion of salt water (e.g., brine) into hydrochloric acid (HCl) and sodium hydroxide (NaOH) for processing biomass into methane, fatty acids, sugars, ethanol, butanol, and/or fertilizer as well as desalinated water, converting energy, generating energy, and/or recycling of waste HCl.

### BACKGROUND

Energy is often created at a steady rate even if the demand for energy fluctuates over time. Additionally, renewable energy generation, such as that from solar and wind power, are controlled by natural forces, which are not responsive to fluctuations in demand. In order to achieve the greatest benefit from these types of power sources, many systems and methods have been developed and currently exist to store energy for later use. These methods and systems include electrochemical cells, compressed air, hydrogen storage and thermal storage. However, each of these systems has drawbacks, which can make their use undesirable.

Currently, one of the primary electrochemical cells used to store electricity for later use is the lead-acid battery. However, these types of batteries do not have a good efficiency rating as both the storage and subsequent usage efficiency is around 72%, resulting in an overall efficiency of approximately 52%. In addition to inefficiency, other components comprising these systems are also required to convert the energy into usable forms, which creates additional power loss.

Electricity can also be stored using hydrogen generation. Specifically, hydrogen can be generated through the electrolysis of water, wherein excess electricity can be used to separate hydrogen and oxygen from water. This hydrogen can then be stored and converted back into energy through the use of a fuel cell or internal combustion engine. While hydrogen storage may not be particularly efficient, fuel cells have been shown to generate electric current with efficiencies as high as 98%.

Other storage methods of excess energy produced can use compressed air. This technique involves compressing air into an abandoned mine or other area at a high pressure. When energy is desired the air is heated with a small amount of natural gas and it travels through turbo expanders to capture the stored energy as the air expands. This process requires the use of large geographical formations or expensive tanks that are capable of withstanding the pressure of the compressed gas. These constraints make this method of storage impractical in any location that does not have such geographical formations.

Finally, new thermal storage processes are being developed in which excess energy in the form of heat is stored as molten salt. The salt is heated through the use of solar panels and is stored in an insulated container. When the energy is desired, water is combined with the molten salt to produce steam, which is used to power generators in the same process that is used for any steam generation fueled process, such as coal. Again, a large storage tank that is capable of keeping the temperature of the salt sufficiently elevated until it is needed is required and such containers can be expensive to produce. Furthermore, this process is primarily only available for use in conjunction with solar energy and it does not address the need associated with other types of energy generation, such as wind.

What is needed is a system that combines several different types of energy storage processes and energy storage processing apparatuses into a unified system that is highly efficient. Additionally, what is also needed is a storage system that can generate byproducts that have uses outside of the electrical storage process.

### SUMMARY OF THE INVENTION

It is an aspect of the present system to provide a highly efficient energy storage and production system that can also create valuable byproducts.

The above aspect can be obtained by a system for storing energy comprising: an electrical source; a chlor-alkali processing apparatus, wherein chlorine gas and hydrogen gas are separated from saltwater via electrolysis driven by the electrical source and sodium hydroxide and desalinated water are created as byproducts; a fuel cell processing apparatus, wherein the chlorine gas and hydrogen gas created by the chlor-alkali processing apparatus are combined to create electricity and hydrochloric acid; a hydrolysis bio-reactor processing apparatus, wherein the hydrochloric acid created in the fuel cell processing apparatus is added to a biomass to create a solution comprising water, hydrochloric acid, and sugar; and a combination electrolysis and neutralization processing apparatus, wherein the solution comprising water, hydrochloric acid, and sugar created by the hydrolysis bio-reactor processing apparatus is combined with the sodium hydroxide created by the chlor-alkali processing apparatus to create chlorine gas and hydrogen gas.

The above aspect can also be obtained by a system for storing energy comprising: an electrical source; a chlor-alkali processing apparatus, wherein chlorine gas and hydrogen gas are separated from saltwater via electrolysis driven by the electrical source and sodium hydroxide and desalinated water are created as byproducts; a fuel cell processing apparatus, wherein the chlorine gas and hydrogen gas created by the chlor-alkali processing apparatus are combined to create electricity and hydrochloric acid; a hydrolysis bio-reactor processing apparatus, wherein the hydrochloric acid created in the fuel cell processing apparatus is added to a biomass to create a solution comprising water, hydrochloric acid, and sugar; and a combination electrolysis and neutralization processing apparatus, wherein the solution comprising water, hydrochloric acid, and sugar created by the hydrolysis bio-reactor processing apparatus is combined with the sodium hydroxide created by the chlor-alkali processing apparatus to create chlorine gas and hydrogen gas; and a ruminant processing apparatus wherein the sodium hydroxide solution created by the chlor-alkali processing apparatus is combined with biomass and water to create methane.

The above aspect can also be obtained by a method for using a system for storing energy, the method comprising: providing a system for storing energy comprising: an electrical source; a chlor-alkali processing apparatus, wherein chlorine gas and hydrogen gas are separated from saltwater via electrolysis driven by the electrical source and sodium hydroxide and desalinated water are created as byproducts; a fuel cell processing apparatus, wherein the chlorine gas and hydrogen gas created by the chlor-alkali processing apparatus are combined to create electricity and hydrochloric acid; an hydrolysis bio-reactor processing apparatus, wherein the hydrochloric acid created in the fuel cell processing apparatus is added to a biomass to create a solution comprising water, hydrochloric acid, and sugar; a combination electrolysis and neutralization processing apparatus, wherein the solution comprising water, hydrochloric acid, and sugar created by the hydrolysis bio-reactor processing apparatus is combined with the sodium hydroxide created by the chlor-alkali processing apparatus to create chlorine gas and hydrogen gas; applying electrical current and seawater to the chlor-alkali processing apparatus; storing the hydrogen gas and chlorine gas; adding the hydrogen gas and chlorine gas to the fuel cell processing apparatus to create electricity and hydrochloric acid; combining the hydrochloric acid created by the fuel cell processing apparatus with biomass in the hydrolysis bio-reactor processing apparatus; and adding the sugar water and hydrochloric acid solution to the combination electrolysis and neutralization processing apparatus.

The above aspect can also be obtained by a method for using a system for storing energy, the method comprising: providing a system for storing energy comprising: an electrical source; a chlor-alkali processing apparatus, wherein chlorine gas and hydrogen gas are separated from saltwater via electrolysis driven by the electrical source and sodium hydroxide and desalinated water are created as byproducts; a fuel cell processing apparatus, wherein the chlorine gas and hydrogen gas created by the chlor-alkali processing apparatus are combined to create electricity and hydrochloric acid; an hydrolysis bio-reactor processing apparatus, wherein the hydrochloric acid created in the fuel cell processing apparatus is added to a biomass to create a solution comprising water, hydrochloric acid, and sugar; a combination electrolysis and neutralization processing apparatus, wherein the solution comprising water, hydrochloric acid, and sugar created by the hydrolysis bio-reactor processing apparatus is combined with the sodium hydroxide created by the chlor-alkali processing apparatus to create chlorine gas and hydrogen gas; and a ruminant processing apparatus wherein the sodium hydroxide solution created by the chlor-alkali processing apparatus is combined with biomass and water to create methane; applying electrical current and seawater to the chlor-alkali processing apparatus; storing the hydrogen gas and chlorine gas; adding the hydrogen gas and chlorine gas to the fuel cell processing apparatus to create electricity and hydrochloric acid; combining the hydrochloric acid created by the fuel cell processing apparatus with biomass in the hydrolysis bio-reactor processing apparatus; and adding the sugar water and hydrochloric acid solution to the combination electrolysis and neutralization processing apparatus.

### BRIEF DESCRIPTION OF THE DRAWINGS

The features and advantages of the present disclosure will be more fully understood with reference to the following, detailed description when taken in conjunction with the accompanying figures, wherein:

FIGS. 1A-1C illustratively depict a broad overview of the systems and methods comprising an energy storage system, and exemplary interactions of various elements of the systems and methods, in accordance with various embodiments of the disclosure;

FIG. 2 illustratively depicts exemplary chlor-alkali production processes, in accordance with various embodiments of the disclosure;

FIG. 3 illustratively depicts exemplary gas storage processes, in accordance with various embodiments of the disclosure;

FIG. 4 illustratively depicts exemplary strong base storage processes, in accordance with various embodiments of the disclosure;

FIG. 5 illustratively depicts exemplary fuel cell processes, in accordance with various embodiments of the disclosure;

FIG. 6 illustratively depicts exemplary strong acid storage processes, in accordance with various embodiments of the disclosure;

FIG. 7 illustratively depicts exemplary hydrolysis bio-reactor processes, in accordance with various embodiments of the disclosure;

FIG. 8 illustratively depicts exemplary combination neutralization and electrolysis processes, in accordance with various embodiments of the disclosure; and

FIG. 9 illustratively depicts exemplary ruminant processes, in accordance with various embodiments of the disclosure.

### DETAILED DESCRIPTION

The invention generally relates to systems and methods for converting, receiving, and/or storing energy to, amongst other things, (i) generate hydrogen (H₂) and chlorine gas (Cl₂), and sodium hydroxide (NaOH) using, for example, a chlor-alkali processing apparatus; (ii) generate hydrochloric acid (HCl) using, for example, a novel HCl fuel cell; (iii) utilize HCl as a catalyst to hydrolyze cellulosic material into basic sugar water and HCl solution; (iv) utilize an acid/base neutralization combined with electrolysis as a precursor to separating HCl from a sugar water and HCl solution; (v) convert HCl to hydrogen (H₂) and chlorine gas (Cl₂); (vi) provide a method by which HCl and/heated water can be used in the transformation of cellulosic materials (e.g., wood, tough stalk material, etc.) into sugars for fermentation into ethanol and/or butanol (vii) provide a method by which acidic waste and additional biomass can be processed through a bio-reactor into methane, fatty acids, and fertilizer; and/or (viii) provide for the desalinization of salt water/brine.

In an embodiments, the systems and methods can provide numerous benefits such as, but not limited to, (i) the ability to store energy in substantially large amounts in stable and relatively safe chemical form; (ii) recoup energy and/or costs expended, for example, in the initial production of acid and base, and water heating with the production of methane, fatty acids, sugars, ethanol, butanol, fertilizer, desalinated water, and energy, to name a few; (iii) desalinated water from, for example, the acid/base production; (iv) use waste material in a bio-reactor to, for example, substantially increase the total energy efficiency of the process and/or allow for longer-term energy storage in methane and/or fatty-acids; (v) and/or provide a net result of the acid/base biomass production of electricity and/or fuels that can be carbon neutral and/or negative.

In an embodiment, the systems and methods can use HCl produced on site and substantially decrease the cost and/or safety issues involved in transporting and storing acid. For example, the acid/base storage system in conjunction with production of electricity and sugars (e.g., that can be processed into ethanol or butanol) from biomass can allow remote communities to produce reliable electricity and/or transport fuels utilizing biomass, salt water/brine, and power sources (e.g., wind, run of river hydro, solar, etc.), for example, without the need for transport of coal, oil, or gas, to name a few.

In an embodiment, the systems and methods can utilize energy from intermittent and/or fluctuating power sources to convert and/or separate acids and bases that can be stored and/or used for processing cellulosic biomass into methane, fatty acids, and sugars to produce and/or store energy and/or potable water. Also, the systems and methods can store in substantially large quantities power from various intermittent or unregulated electric supplies at a substantially low cost. Further, the systems and methods can provide low cost reservoirs of acids (e.g., aqueous HCl) and/or bases (e.g., aqueous NaOH) for use in bioprocesses which can be used to produce sugars, fatty acids, and methane, to name a few. Further still, the systems and methods can convert substantial large quantities of seawater into potable water at substantially low cost.

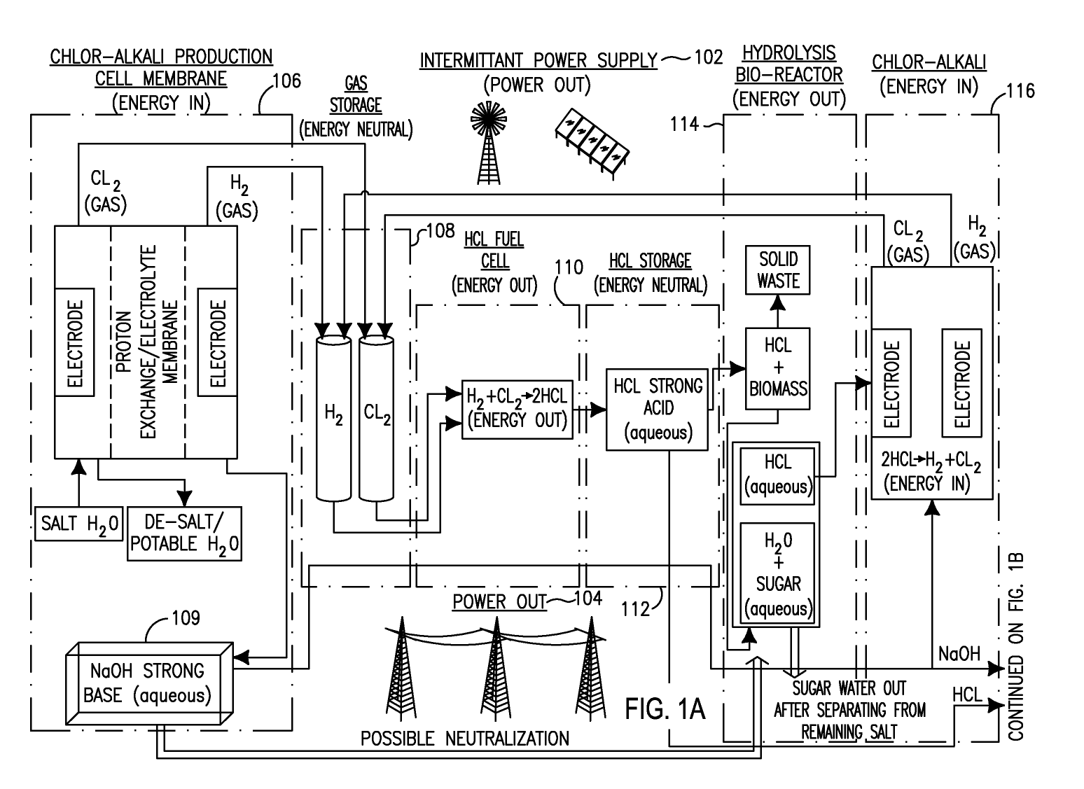

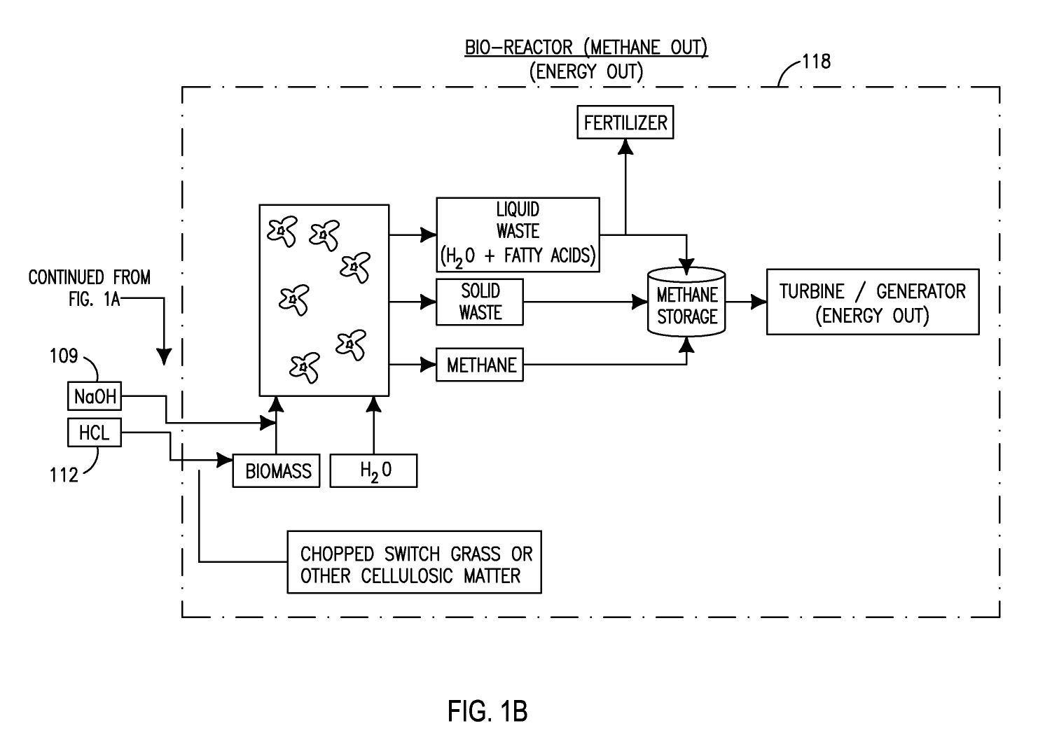

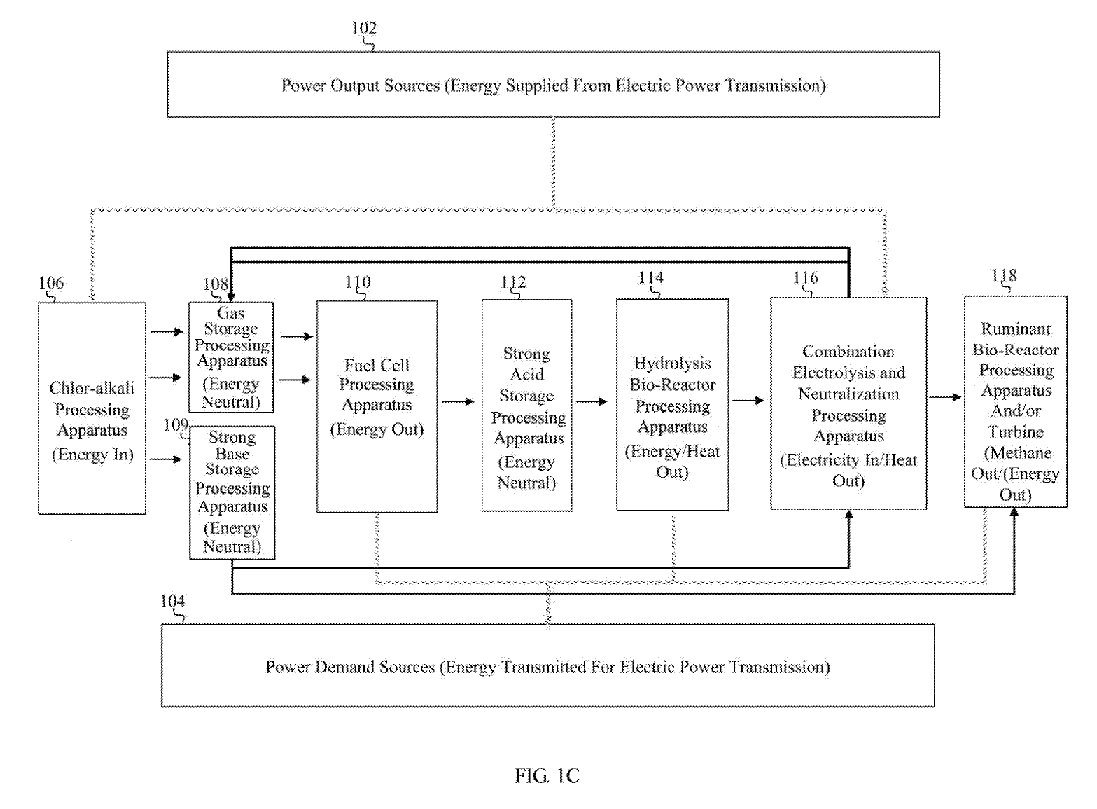

Referring to FIGS. 1A-1B, in an embodiment, electrical energy from power output sources 102 can be used to power various aspects of the system and methods such that energy can output to power demand sources 104 (e.g., electric grids, houses, etc.). For example, energy from power output sources 102 can be used to power a chlor-alkali processing apparatus 106 and a combination electrolysis and neutralization processing apparatus 116. Further, energy can be output to power demand sources 104 from a fuel cell processing apparatus 110, a hydrolysis bio-reactor processing apparatus 114, and/or a ruminant bio-reactor processing apparatus 118.

As explained in greater detail below, electrical energy from power output sources 102 can be used to power chlor-alkali processing apparatus 106 such that salt water can be separated into hydrogen and chlorine gas, stored using a gas storage processing apparatus 108, as well as a strong base, stored using a strong base storage processing apparatus 109. This strong base can be used as an input with biomass to enable ruminant bio-reactor processing apparatus 118 to convert the biomass into methane and/or this strong base can be used as an input in combination electrolysis and neutralization processing apparatus 116.

While the storage processing apparatus envisioned in 108/109 can comprise one embodiment, the compressed gases and NaOH solution can also be transported to separate locations via compressed gas canisters and liquid transport respectively. This would allow the fuel cell and hydrolysis facilities to be at a different location from the power generation facility and allow for multiple remote power generation facilities.

In an embodiment, the hydrogen and chlorine gas, for example, from gas storage processing apparatus 108, can be recombined into aqueous hydrochloric acid (HCl) as part of fuel cell processing apparatus 110 that can generate electricity. For example, at times and durations (e.g., chosen by the operator) by restricting the flow of gas from gas storage processing apparatus 108 the hydrogen and chlorine can be recombined into aqueous HCl as part of fuel cell processing apparatus 110 thereby generating electricity. The aqueous HCl can then be stored using a strong acid storage processing apparatus 112. When desired, using hydrolysis bio-reactor processing apparatus 114, the strong acid, from strong acid storage processing apparatus 112, can be used to hydrolyze biomass into a strong acid and sugar water solution and solid waste can be removed.

After the solid waste is removed, the hydrogen and chlorine gas can be recycled out of a solution that can include HCl, sugar, and water, to name a few, using combination electrolysis and neutralization processing apparatus 116, and can then be stored, for example, using gas storage processing apparatus 108. Further, using combination electrolysis and neutralization processing apparatus 116, the hydrogen and chlorine gas can be recycled out of the solution that can include HCl, sugar, and water, to name a few by a combination of neutralization with a strong base, for example sodium hydroxide (NaOH), from strong base storage processing apparatus 109, and electrolysis.

Further, a liquid phase separation process can be used to separate the sugar from the salt water. Once the HCl has been neutralized in the batch/container, the resulting salt/sugar solution will be mixed with a non-aqueous solvent (currently mineral oil) in which sugar dissolves, but into which salt does not dissolve. The solvent is then mixed with fresh/desalinated water to release the sugar and create a pure sugar solution.

In an embodiment, NaOH, for example, from a strong base storage processing apparatus 109, biomass, and water, to name a few can be used in ruminant bio-reactor processing apparatus 118 to generate, amongst other things, methane, fatty acids, and sugar solutions. The methane and fatty acids produced can be burned immediately and/or stored for future energy needs and the sugar solution can be further fermented into, for example, ethanol and/or butanol. In some instances, HCl (both gaseous and aqueous) and/or heated water can be used in the transformation of cellulosic materials (e.g., wood, tough stalk material, etc.) into sugars for fermentation into ethanol and/or butanol.

In an embodiment, waste acid and base can be used to neutralize end products on the other side of the process leading to a substantially efficient and/or ecologically friendly system. By way of example, NaOH, for example, from the storage processing apparatus 109 can be used to neutralize the HCl in the HCl/sugar solution at the end of the hydrolysis. Further, NaOH can also be used to neutralize at least some of the acidic solid waste from that process. In an embodiment, the base and acid can cancel each other out or the bio-process can create at least some acid.

In an embodiment, power output sources 102 can generate and/or deliver electrical energy from any source such as, but not limited to, turbines, nuclear fission, fossil fuels, biomass, solar parabolic troughs, solar power towers, geothermal power, ocean thermal energy conversion, hydroelectric, hydroelectric dams, tidal forces, wind turbines, solar updraft towers, photovoltaics, photovoltaic panels, thermoelectric (te) devices, thermionic (ti) and thermophotovoltaic (tpv) systems, piezoelectric devices, betavoltaics, fluid-based magnetohydrodynamic (mhd) power generation, nuclear reactors, osmotic power, electrochemical electricity generation, biofuel, hydroelectricity, solar energy, tidal power, wave power, wind generated electricity, solar, run-of-river hydroelectric, off-peak power, any combination and/or separation thereof, and/or any source capable of generating and/or delivering electrical energy.

For ease, power output sources 102 are described, at times, as being wind generated electricity. This is merely for ease, and is in no way meant to be a limitation. Further, it will be understood that power output sources 102 can produce intermittent power that can, for example, have a variable voltage and/or frequency that can require, amongst other things, a power converter.

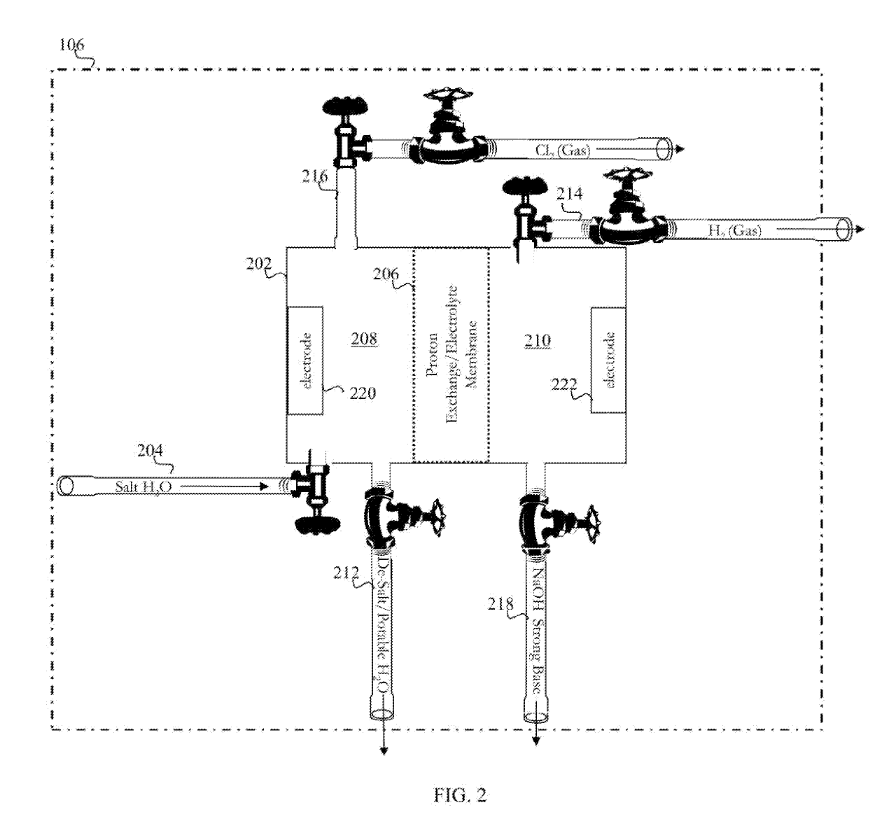

Referring to FIG. 2, in an embodiment, chlor-alkali processing apparatus 106 can be used for the electrolysis of sodium chloride solution (e.g., brine, salt water, etc.) to produce and/or separate gases such as, but not limited to, hydrogen gas, chlorine gas, and any other gas; to produce and/or generate strong bases, for example, aqueous sodium hydroxide (NaOH); to produce and/or generate other fluids, for example, de-salted water, potable water, and any other fluid and/or aqueous solution.

In an embodiment, chlor-alkali processing apparatus 106 can utilize power from power output sources 102 (not shown) that can be supplied to a tank 202 with an inflow of brine/salt water 204. Tank 202 can have any number of proton exchange/electrode membrane(s) 206 (e.g., any number of Nafion barriers) separating tank 202 into a first chamber 208 and a second chamber 210. Salt water intake 204, a desalinated outflow 212, or chlorine gas outflow 216 are on one side of proton exchange/electrode membrane(s) 206 and a fresh/desalinated water intake (not shown), an aqueous NaOH outflow 218, and/or hydrogen gas outflow 214 and/or chlorine gas outflow 216 are on the other side of the proton exchange/electrode membrane(s) 206. Further, in an embodiment, power can be applied via first electrode 220 and second electrode 222 on opposite sides of tank 202 creating a NaOH solution on one side that can flow out to a separate tank. Further still, in an embodiment, hydrogen and chlorine gas can be generated by the electrodes and collected via vents and sent to storage tanks.

In an embodiment, thermometers, pH detectors, and/or liquid level detectors can be placed on either and/or both sides of tank 202 with, for example, readouts outside tank 202 such that users can monitor the system functions, regulate the flows into and out of tank 202, and/or regulate power.

It will be understood that a chlor-alkali processing apparatus 106 can be modified and/or replaced with any other suitable process capable of supplying and/or producing hydrogen, chlorine, sodium hydroxide, and/or any other strong base. For ease, a chlor-alkali processing apparatus 106 can be described, at times, as the process for supplying and/or producing hydrogen, chlorine, sodium hydroxide, and/or any other strong base. This is merely for ease and is in no way meant to be a limitation.

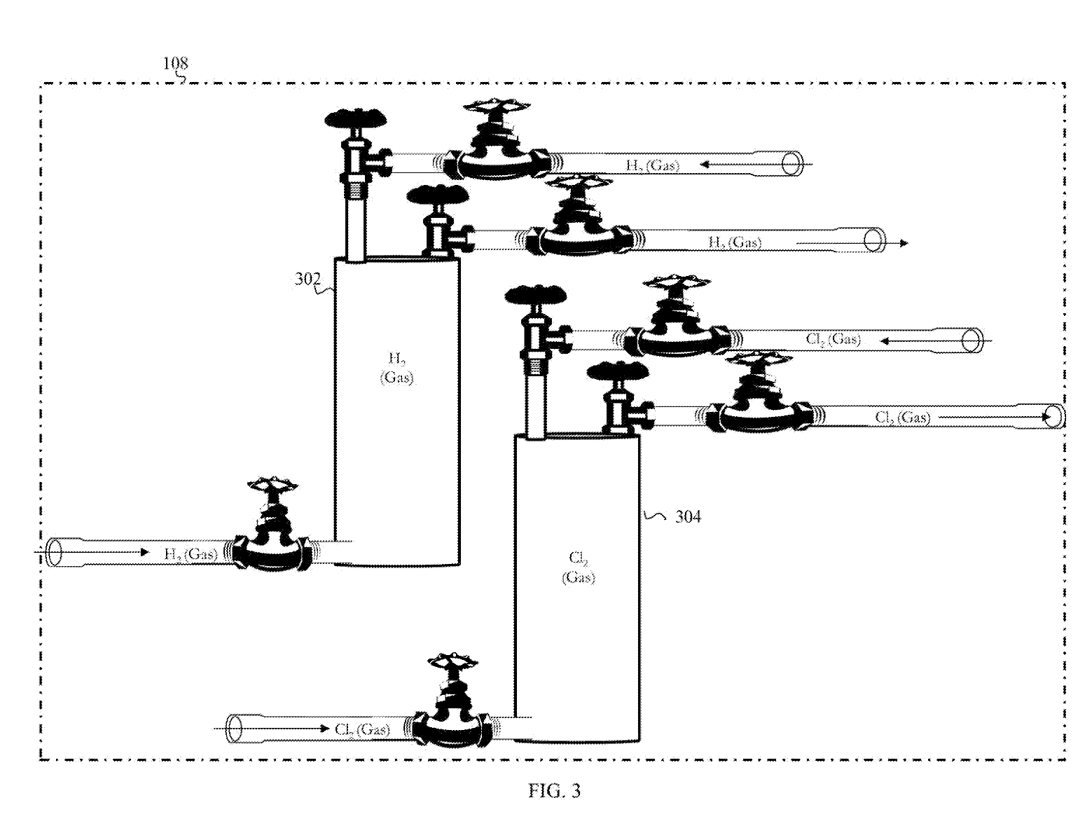

Referring to FIG. 3, at gas storage processing apparatus 108, hydrogen can be stored in a hydrogen container 302 and/or hydrogen can be stored using any technique such as, but not limited to, high pressure storage, cryogenic storage, and stored with chemical compounds that reversibly release H₂ upon heating, any combination and/or separation thereof, and/or by any reasonable hydrogen storage technique. Further, at gas storage processing apparatus 108, chlorine can be stored in a chlorine container 304. In an embodiment, the storage technique for the hydrogen and/or chlorine can vary in type and/or size based on, amongst other things, the amount of energy that may be desired to be stored.

In an embodiment, chlorine can be stored as liquid and/or gas. Chlorine can be liquefied for larger, longer term storage with a liquefier system such as, but not limited to, those produced by York or Mycom. In an embodiment, chlorine container 304 can be a chlorine tank such as, but not limited to, those manufactured by Kadoya Everbright Trading (Dalian) Co., Ltd.

In an embodiment, hydrogen container 302 can be a gas storage system such as, but not limited to, those manufactured by Hank and/or Praxair. In a further embodiment, hydrogen container 302 can store hydrogen utilizing a liquefied petroleum gas tank and/or hydrogen container 302 can be required to follow some guidelines (NFPA 55) regarding safety.

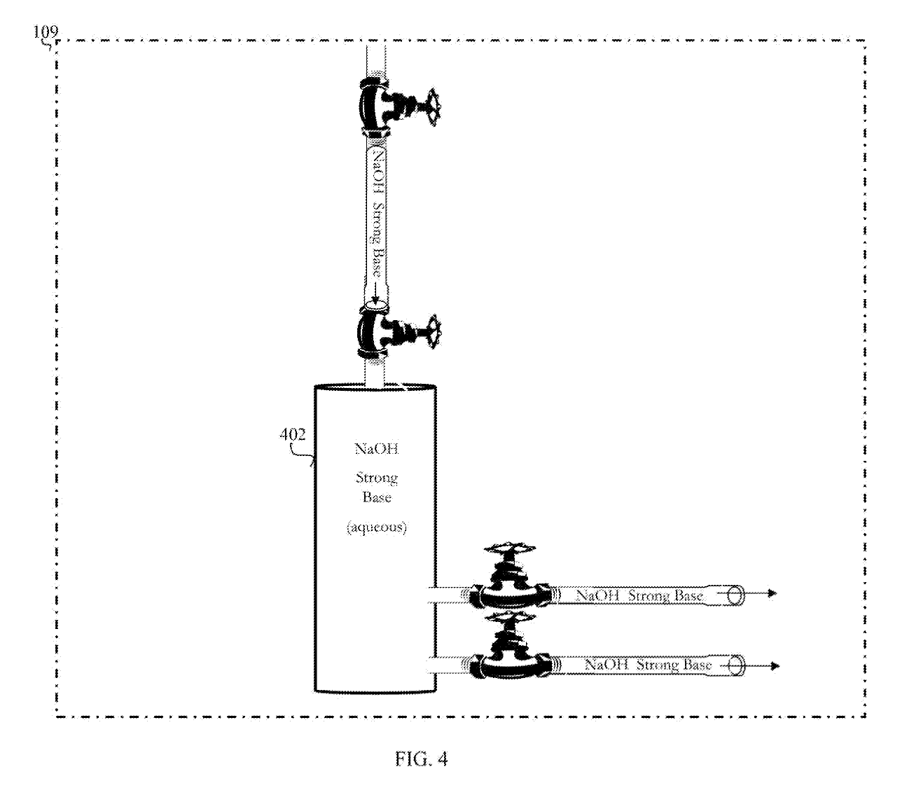

Referring to FIG. 4, strong base storage processing apparatus 109, NaOH can be stored in a NaOH container 402. In an embodiment, NaOH can be stored in a NaOH container 402 that can be a tank such as, but not limited to, those manufactured by Snyder Industries.

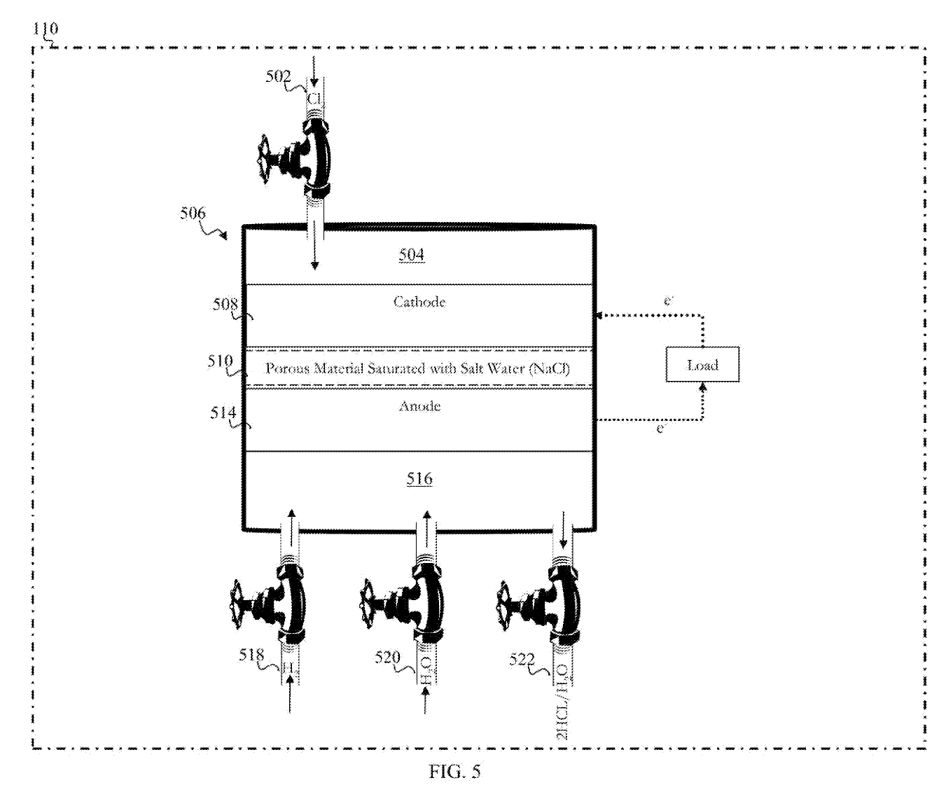

Referring to FIG. 5, in an embodiment, at fuel cell processing apparatus 110, as necessary, hydrogen gas and chlorine gas can be recombined into aqueous HCl and/or electricity can be extracted. In an embodiment, the hydrogen and chlorine can flow from their respective tanks 302/304 as needed and/or can be recombined through a stack of fuel cells into aqueous HCl which can be stored for use in hydrolysis. In an embodiment, the stack of cells can be determined by the required output voltage. Of course, the hydrogen and chlorine flow can come from other sources.

In an embodiment, fuel cell processing apparatus 110 can combine hydrogen gas and chlorine gas into HCl and electricity by, for example, enabling chloride ions to migrate in an electrolyte. In an embodiment, enabling chloride ions to migrate in an electrolyte can allow for the use of less expensive catalysts (e.g., nickel instead of platinum) and/or substantially reduce problems associated with alkaline fuel cells (e.g., CO2 poisoning of the electrolyte and carbonate build-up in the system).

Still referring to FIG. 5, in an embodiment, by way of example, chlorine gas 502 can be released into a top compartment 504 of a fuel cell 506 wherein chlorine gas 502 can flow downwards to contact a cathode 508 (e.g., a nickel mesh, nickel alloy mesh, etc). Further, cathode 508 can sit on top of an asbestos and/or other porous material layer 510 saturated with salt water (aqueous NaCl and/or aqueous KCl). Beneath layer 510 can be an anode 514 (e.g., a nickel mesh, nickel alloy mesh, etc.) which can border the bottom compartment 516 of fuel cell 506. Further still, hydrogen gas 518 can be released into bottom compartment 516 and/or bottom compartment 516 can have a water trap below (not shown) with a water input 520 and/or HCl/water output valves 522. Electricity can flow through anode 514 and/or cathode 508 in a circuit and/or aqueous HCl 522 can be dispensed at the bottom. Fuel cell 506 and/or any elements of it can be made of acid resistant materials (e.g., Teflon, Pyrex, etc.).

It will be understood that the above fuel cell processing apparatus 110 is an example of one fuel cell for use in the overall systems and methods disclosed. Other types and forms of fuel cells are within the scope of the disclosure. For ease, only the above fuel cell is described. This is merely for ease and is in no way meant to be a limitation.

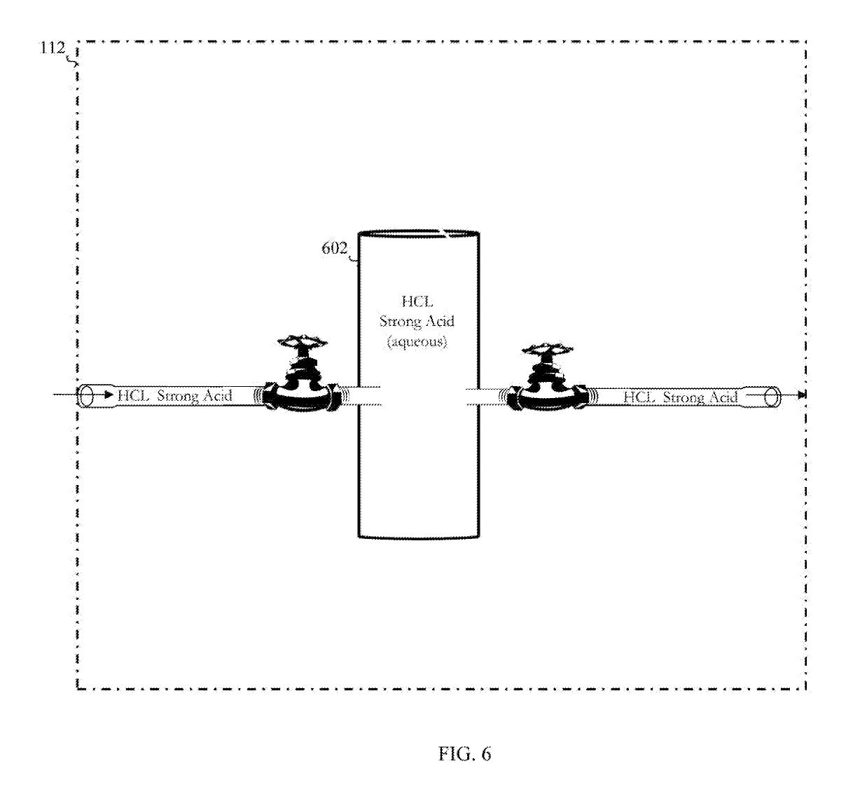

Referring to FIG. 6, strong acid storage processing apparatus 112, hydrochloric acid can be stored in a hydrochloric acid container 602 that can be a plastic coated glass container and/or any other container capable of storing a strong acid. Further, HCl can be stored in concentrated aqueous form in any container (e.g. HCl storage tanks) capable of storing strong acid. For example, it can be stored in containers manufactured by Spirall Plastics (chemicalstoragetank.net), which can be one of many possible suppliers.

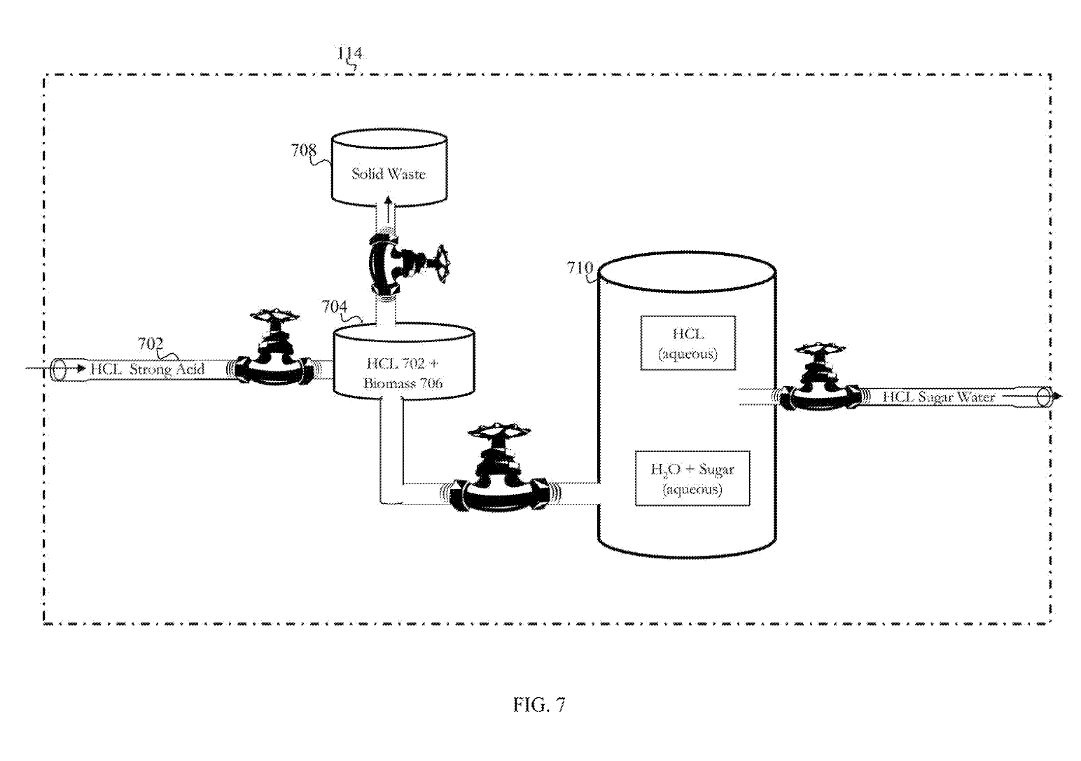

Referring to FIG. 7, in an embodiment, at hydrolysis bio-reactor processing apparatus 114, outflow of HCl 702 can be sent to a hydrolysis apparatus 704 where HCl 702 can be combined in relatively high concentration with cellulosic biomass 706. After processing, the solid waste 708 can be separated and/or filtered and/or the resulting liquid 710 can be primarily water, HCl, and sugar.

In an embodiment, similar to the techniques disclosed below at ruminant bio-reactor processing apparatus 118, cellulosic biomass 706 (e.g., pulped sawgrass) and/or the separated and/or filtered solid waste 708 can be processed into methane, acetic acid, and/or solid waste. Further, the methane/acetic acid can be stored and burned in a gas turbine for electricity. Further in an embodiment, the acetic acid can be burned directly or heated to produce methane to burn. Alternatively, due to the fact that acetic acid is relatively easy to transport, it may also become an end-product. Although cellulosic biomass 706 is described in the embodiment described above, non-cellulosic biomass can be used instead or in combination with cellulosic biomass 706.

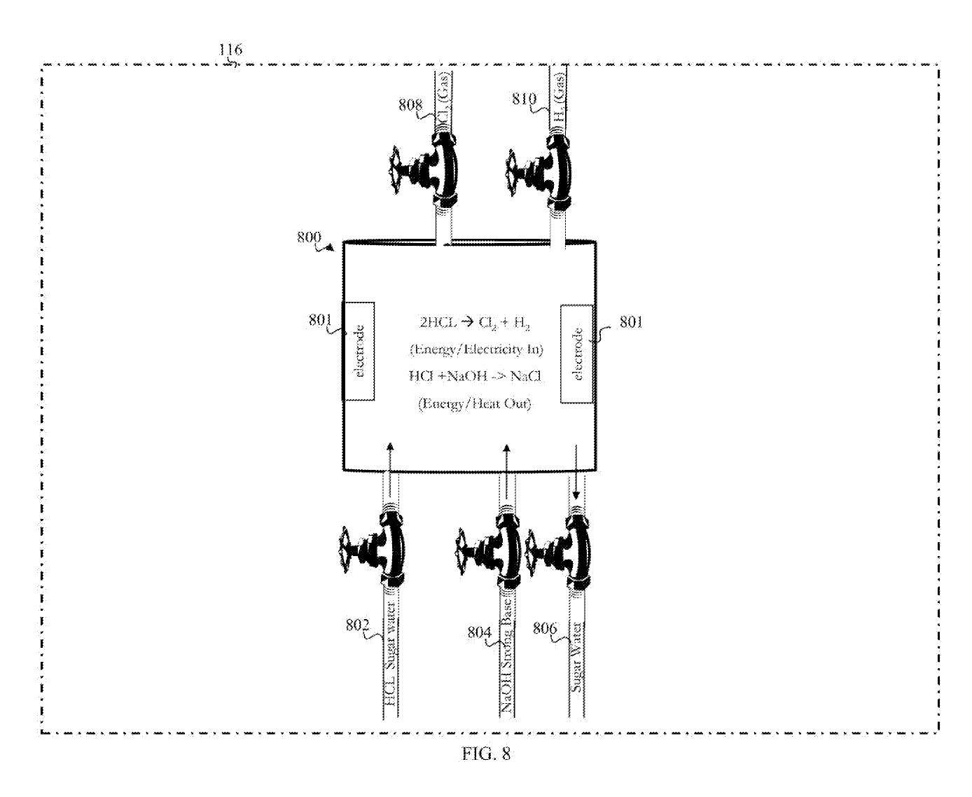

Referring to FIG. 8, in an embodiment, at combination electrolysis and neutralization processing apparatus 116, the systems and methods can use an acid/base neutralization combined with electrolysis as a precursor to the separation of sugar. For example, HCl and sugar water 802 and NaOH 804 can be input into electrolysis and neutralization container 800 including electrodes 801. In another example, HCL and sugar water 802 can be input into electrolysis and neutralization container 800 including electrodes 801. Further, in an embodiment, a liquid phase separation process can be used to separate the sugar from the salt water.

In electrolysis and neutralization container 800, electrolysis of HCl can be used to convert HCl (e.g. affiliated with HCl and sugar water 802) to hydrogen gas 810 and chlorine gas 808 that can be pumped into storage tanks, for example at gas storage processing apparatus 108. Further, in an embodiment, any remaining acid can be, if needed, neutralized with NaOH 804 resulting in a substantially neutral salt solution. The substantially neutral salt water solution can then undergo a liquid phase separation to, for example, separate the sugar from the salt water. By way of example, after neutralizing HCl (e.g., neutralized in a batch/container) the resulting salt and/or sugar solution can be mixed with non-aqueous solvent (e.g., mineral oil) in which sugar dissolves and/or in which salt does not dissolve. The solvent can then be mixed with fresh/desalinated water to release the sugar and/or create a pure sugar solution. Of course, other techniques for separating the sugar from the salt water are within the scope of the present disclosure.

It will be understood that the terms “sugar” and “sugar water” as well as similar terms, can refer to any reasonable form of sugar such as, but not limited to, sucrose, glucose, fructose, lactose, any combination and/or separation thereof, and/or any other reasonable form of sugar. For ease, by way of example, the hydrolysis process described can convert cellulose into glucose. Of course, other techniques for generating and/or converting cellulose and/or any form of sugar are within the scope of the disclosure.

Further, approximately 60-70% of the energy expended in the electrolysis can be stored. By way of example, utilizing a process and/or techniques disclosed, energy can be stored enabling it to be converted and/or become output from fuel cell processing apparatus 110, hydrolysis bioreactor 114, and/or ruminant bioreactor processing apparatus 118, to name a few.

Further, in an embodiment, at combination electrolysis and neutralization processing apparatus 116 sugar water 808 can flow out and/or can be processed into ethanol and/or butanol.

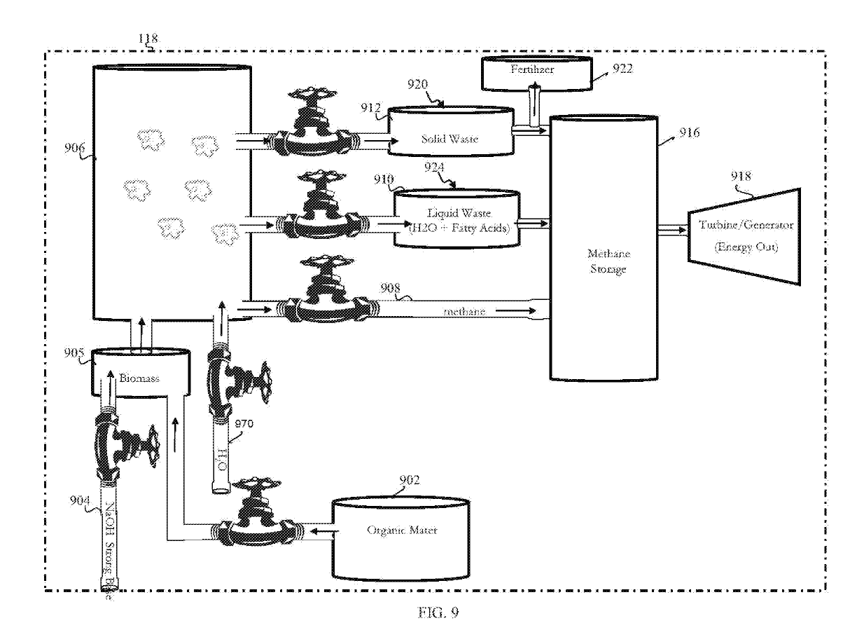

Referring to FIG. 9, in an embodiment, at ruminant bio-reactor processing apparatus 118, organic matter 902 (e.g., switch grass, other cellulosic matter usable for a bio-reactor, etc.) can be cut into small particles or pieces (e.g., 2 cm square or less) by a machine (e.g., chipper, grinder, etc.) and/or sprayed with NaOH solution 904. NaOH solution 904 can be sprayed on organic matter 902 to bring the biomass to a pH of 6.8. NaOH solution 904 can come from a storage tank, for example, from a storage tank at strong base storage processing apparatus 109.

It will be understood that organic matter 902 can be cut into small particles using any reasonable machine such as, but not limited to, chippers, grinders, any combination and/or separation thereof, and/or any reasonable machine capable of cutting organic matter into small particles or pieces. By way of example, organic matter can be cut into small particles or pieces using a 2003 Stedman 20×12 Twin electric Stationary Grinder. Of course, other techniques and/or machines for cutting organic matter into small particles are within the scope of the present disclosure.

In an embodiment, organic matter 902 can be sprayed with NaOH solution 904 forming a biomass 905 that can be placed into a rumination unit 906. In other embodiments, organic matter 902 can be sprayed with a NaOH solution 904 forming a biomass 905 located in a rumination unit 906. In an embodiment, organic matter 902 and NaOH solution 904 can be placed into a rumination unit 906 that can be sealed, pH controlled, and/or temperature controlled. In rumination unit 906, NaOH solution 904 can be used to control pH, for example, in the event that inflows of NaOH treated biomass 905 and outflows (e.g., fatty acids) do not maintain a stable pH.

In an embodiment, rumination unit 906 can include a water inflow 970. Further, in an embodiment, rumination unit 906 can contain bacteria such as, but not limited to, those found in ruminating animals (cows, goats, etc.). Further, outflows from rumination unit 906 can include, but is not limited to, gaseous methane 908, liquid waste 910 that can include water and/or fatty acids, and solid waste 912, to name a few.

Further, in an embodiment, NaOH solution 904 and HCl (not shown) can be used to control the pH to, for example, optimize for the bacteria in rumination unit 906.

In an embodiment, methane 908 can be collected in a storage tank 916, for example, for burning in a turbine 918. Further, solid waste 912 can be kept in a separate tank 920 to continue collecting methane, for example, that can be collected in storage tank 916 for burning in turbine 918, and/or solid waste 912 can then be removed, for example, for sale as fertilizer 922. Further still, liquid waste 910 can be kept in a separate tank 924 and dehydrated (e.g., by evaporation or other means) and liquid waste 910 and/or the eventual (dehydrated) waste 910 can be heated to produce more methane that can be collected in storage tank 916, for example, for burning in turbine 918.

In an embodiment, water input can be filtered seawater and/or at various points of the process the water outflow can be calibrated to be directly suitable as drinking water and/or to be a low saline feeder into a desalination processing apparatus.

It will be understood that any of the steps described can be rearranged, separated, and/or combined without deviating from the scope of the invention. For ease, steps are, at times, presented sequentially. This is merely for ease and is in no way meant to be a limitation.

Further, it will be understood that any of the elements and/or embodiments of the invention described can be rearranged, separated, and/or combined without deviating from the scope of the invention. For ease, various elements are described, at times, separately. This is merely for ease and is in no way meant to be a limitation.

While the various steps, elements, and/or embodiments of the invention have been outlined above, it is evident that many alternatives, modifications and variations will be apparent to those skilled in the art. The various steps, elements, and/or embodiments of the invention, as set forth above, are intended to be illustrative, not limiting. Various changes may be made without departing from the spirit and scope of the invention. Accordingly, the spirit and scope of the present invention is to be construed broadly and limited only by the appended claims and not by the foregoing specification.

What is claimed is:

1. A system for storing energy comprising:
an electrical source;
a chlor-alkali processing apparatus, wherein chlorine gas and hydrogen gas are separated from saltwater via electrolysis driven by the electrical source and sodium hydroxide and desalinated water are created as byproducts;
a fuel cell processing apparatus, wherein the chlorine gas and hydrogen gas created by the chlor-alkali processing apparatus are combined to create electricity and hydrochloric acid;
a hydrolysis bio-reactor processing apparatus, wherein the hydrochloric acid created in the fuel cell processing apparatus is added to a biomass to create a solution comprising water, hydrochloric acid, and sugar; and
a combination electrolysis and neutralization processing apparatus, wherein the solution comprising water, hydrochloric acid, and sugar created by the hydrolysis bio-reactor processing apparatus is combined with the sodium hydroxide created by the chlor-alkali processing apparatus to create chlorine gas and hydrogen gas.

2. A system as described in claim 1 wherein the chlor-alkali processing apparatus comprises a tank divided by a proton exchange membrane into a first side and a second side, wherein a first electrode located on the first side of the tank and a second electrode located on the second side of the tank.

3. A system as described in claim 1 wherein the hydrogen gas created by the chlor-alkali processing apparatus is stored in a hydrogen container and the chlorine gas created by the chlor-alkali processing apparatus is stored in a chlorine container.

4. A system as described in claim 1 wherein the electrical source is one or more wind generators.

5. A system as described in claim 1 wherein the electrical source is photovoltaics.

6. A system as described in claim 1 wherein the fuel cell processing apparatus comprises a platinum catalyst.

7. A system as described in claim 1 wherein the combination electrolysis and neutralization processing apparatus occurs in a neutralization container comprising two electrodes.

8. A system as described in claim 1, the system further comprising:
a ruminant processing apparatus wherein the sodium hydroxide solution created by the chlor-alkali processing apparatus is combined with biomass and water to create methane.

9. A system as described in claim 8 wherein the methane can be used to power a generator.

10. A system as described in claim 8 wherein the ruminant processing apparatus creates solid waste, which can be used as fertilizer.

11. A system as described in claim 8 wherein the chlor-alkali processing apparatus comprises a tank divided by proton exchange membrane into a first side and a second side, wherein a first electrode located on the first side of the tank and a second electrode located on the second side of the tank.

12. A system as described in claim 8 wherein the hydrogen gas created by the chlor-alkali processing apparatus is stored in a hydrogen container and the chlorine gas created by the chlor-alkali processing apparatus is stored in a chlorine container.

13. A system as described in claim 8 wherein the combination electrolysis and neutralization processing apparatus occurs in a neutralization container comprising two electrodes.

14. A system as described in claim 8 wherein the electrical source is one or more wind generators.

15. A system as described in claim 8 wherein the electrical source is photovoltaics.

16. A system as described in claim 8 wherein the fuel cell processing apparatus comprises a platinum catalyst.

17. A system as described in claim 1 wherein the sugar added to the combination electrolysis and neutralization processing apparatus is sucrose, glucose, fructose, lactose or a combination of these sugars.

18. A system as described in claim 1 wherein the sugar water byproduct is converted into ethanol or butanol.

19. A method for using a system for storing energy comprising, the method comprising:
Providing a system for storing energy comprising: an electrical source; a chlor-alkali processing apparatus, wherein chlorine gas and hydrogen gas are separated from saltwater via electrolysis driven by the electrical source and sodium hydroxide and desalinated water are created as byproducts; a fuel cell processing apparatus, wherein the chlorine gas and hydrogen gas created by the chlor-alkali processing apparatus are combined to create electricity and hydrochloric acid; a hydrolysis bio-reactor processing apparatus, wherein the hydrochloric acid created in the fuel cell processing apparatus is added to a biomass to create a solution comprising water, hydrochloric acid, and sugar; a combination electrolysis and neutralization processing apparatus, wherein the solution comprising water, hydrochloric acid, and sugar created by the hydrolysis bio-reactor processing apparatus is combined with the sodium hydroxide created by the chlor-alkali processing apparatus to create chlorine gas, hydrogen gas; and
applying electrical current and seawater to the chlor-alkali processing apparatus;
storing the hydrogen gas and chlorine gas;
adding the hydrogen gas and chlorine gas to the fuel cell processing apparatus to create electricity and hydrochloric acid;
combining the hydrochloric acid created by the fuel cell processing apparatus with biomass in the hydrolysis bio-reactor processing apparatus; and
adding the sugar water and hydrochloric acid solution to the combination electrolysis and neutralization processing apparatus.

20. A method as described in claim 19, the method further comprising:
a ruminant processing apparatus wherein the sodium hydroxide solution created by the chlor-alkali processing apparatus is combined with biomass and water to create methane.
